(19) United States
(12) Patent Application Publication
(10) Pub. No.: US 2008/0242173 A1
(43) Pub. Date: Oct. 2, 2008

(54) UV light- and moisture-resistant textile barrier

(76) Inventors: Ari L. Markow, Los Angeles, CA (US); Michael Markow, Westlake Village, CA (US)

Correspondence Address: ETHERTON LAW GROUP, LLC, 5555 E. VAN BUREN STREET, SUITE 100, PHOENIX, AZ, 85008, US

(21) Appl. No.: 11/728,735

(22) Filed: Mar. 27, 2007

(51) Int. Cl. B32B 5/02

(52) U.S. Cl. 442/71; 442/135

(57) ABSTRACT

A barrier for protecting contents such as insulation materials or ballistic materials that can be used with body armor or other protective gear. The protective panel comprises a barrier of ultraviolet light- and moisture-resistant fabric ultrasonically welded at its edges and a protective material encased therein. The ultrasonic weld is also ultraviolet light- and moisture-resistant. In the preferred embodiment, the molecular bonds created by the ultrasonic energy are such that a first set of bonds is oriented to a second set of bonds at 90 degrees and both sets of bonds are oriented to the fabric edge at 45 degrees. Optionally, the protective panel can include one or more attachment affixed to the exterior of the barrier using heat.

### CROSS-REFERENCE TO RELATED APPLICATIONS

This application claims the benefit of co-pending provisional application No. 60/785,381 filed Mar. 27, 2006.

### FIELD OF INVENTION

This invention generally relates to the field of textiles. In particular, this invention relates to a protective barrier that substantially prevents environmental damage to the contents encased by the barrier. More particularly, this invention relates to an ultraviolet light- and moisture-resistant barrier for encasing insulating materials or ballistic materials to be used in body armor or other protective gear.

### BACKGROUND

Certain occupations require its workers to be exposed to a variety of hazardous and dangerous conditions. Such hazardous and dangerous conditions include exposure to extremely cold weather, sharp objects, explosives, and projectiles such as bullets. Examples of occupations wherein the worker may be exposed to such hazardous and dangerous conditions include construction, metal and glass working, law enforcement, corrections, emergency medicine, safety, security and the military.

Over time, a variety of textile materials have been developed that have certain protective attributes making these textile materials optimum for use in the construction of safety and protective clothing. For example, police officers and military personnel wear protective body armor such as bulletproof vests, which comprise a number of ballistic panels made with layers of strong web-like material capable of deflecting projectiles and dissipating their energy that are inserted or otherwise carried by the vest. Textiles particularly useful for protecting a user from hazardous and dangerous conditions include: aramid fabrics such as Kevlar®, Nomex®, and Twaron®; high performance polyethylene systems such as Dyneema® and Spectra Fibers ®; aramid barriers such as ColdFlox®; poly-p-phenylene benzobisoxazole (PBO) fabrics such as Zylon®; and insulation materials such as down, synthetic fibers and woolen materials.

Unfortunately, the protective attributes of certain textile materials are susceptible to degradation and a decrease in performance as a result of exposure to certain physical influences. In particular, moisture and ultraviolet (UV) light can significantly degrade certain textiles and decrease their performance. For example, on Aug. 24, 2005, the U.S. Department of Justice, Office of Justice Programs, National Institute of Justice, issued its “Third Status Report to the Attorney General on Body Armor Safety Initiative Testing and Activities” claiming that preliminary investigations determined that PBO fabrics, such as Zylon®, degrade as a result of exposure to moisture and light, and that consequently the PBO fabric's performance with respect to bullet resistance may be compromised. Other independent reports indicate that untreated aramid fabrics and aramid barriers are also susceptible to degradation and a decrease in performance when exposed to moisture or UV light. Down, when directly exposed to moisture, is also susceptible to decreased performance of its protective properties with respect to insulation.

In an effort to prevent degradation, manufactures of safety and protective clothing place the susceptible textiles in nylon pouches or cases with seams comprising a single needle stitch. There are two significant problems with this current solution, however. First, manufacturers often construct the nylon pouch from nylon that does not block UV light. Second, the seam created by this standard method of pouch construction still permits significant intrusion of both moisture and UV light as they permeate the pouch through the holes created by the single needle stitch. This problem is further exacerbated when additional components are sewn with needle and thread onto the pouch so that the pouch can be affixed to or suspended from another garment or so additional items can be affixed to the pouch.

Thus, it is clear that there is a great need in the art for an improved barrier that protects insulating and ballistic materials from being exposed to UV light, moisture and other environmental factors. Moreover, there is a great need for a barrier that guards against such environmental damage while not compromising comfort or the effectiveness of the materials encased within the barrier.

Accordingly, one object of this invention is to provide a moisture-resistant and ultraviolet light-resistant barrier of any shape or size that is used to encase and protect materials such as those used in protective gear.

Another objective of the invention is to provide attachments, such as hook and loop components, to the barrier without making any perforations in the barrier, such that the integrity of the barrier is preserved.

Another objective of the invention is to create an environmental barrier that remains flexible enough to be comfortable when worn by the user and that is useful in protective clothing.

A further objective of the invention is to extend the useful life of insulating or ballistic materials that are used in protective clothing and gear by substantially diminishing the materials' exposure to moisture and UV light. As a result, the overall cost of the protective gear is substantially reduced, and the protection and performance of the protective gear is consistent over longer periods of time.

### SUMMARY OF THE INVENTION

This invention is a barrier that encases materials vulnerable to degradation from environmental elements such as ultraviolet light and moisture. In particular, the barrier is used to encase safety and protective materials such as insulating materials or ballistic materials. The barrier and its contents, which together form a protective panel, can then be placed strategically within body armor or other protective gear.

The barrier comprises fabric panels connected to each other with seams that are substantially impermeable to UV light and moisture. In the preferred embodiment, the fabric panels are comprised of 100 denier nylon coated with urethane, although any material that can withstand a minimum of two pounds per square inch of water pressure and has a low ultraviolet light rating can be used. In the preferred embodiment, the edges of the panels are welded together by applying ultrasonic energy. The molecular bonds created by the ultrasonic energy are such that a first set of bonds is oriented to a second set of bonds at 90 degrees, and both sets of bonds are oriented to the fabric edge at 45 degrees. Optionally, the barrier includes an attachment affixed by heat to its exterior.

### BRIEF DESCRIPTION OF THE DRAWINGS

FIG. 1 is front view of a bulletproof vest incorporating the preferred embodiment of this invention.

FIG. 2 is a cross-section of the barrier of this invention surrounding ballistic materials.

FIG. 3 is a top view of the preferred embodiment of the barrier of this invention.

FIG. 4 is a top view of the preferred embodiment of the barrier of this invention and a close-up view of the seam, showing an optional attachment feature.

FIG. 5 is a cross-sectional view of the preferred embodiment of the barrier of this invention with an optional attachment feature.

### DETAILED DESCRIPTION OF THE INVENTION

This invention is a barrier 20 for encasing materials vulnerable to degradation or decreased performance upon short- or long-term exposure to environmental elements such as moisture or ultraviolet light. For example, in a down vest, the barrier 20 protects moisture from reaching the down, which would lose its insulating properties if exposed to moisture. Another example is a bulletproof vest in which the barrier 20 prevents ultraviolet light and moisture from reaching the ballistic material 23 and thereby prevents degradation of the ballistic material. The barrier and its contents together form a protective panel. When a protective panel protects primarily against ballistics, it is referred to herein as a ballistic panel; if a protective panel primarily insulates, it is referred to herein as an insulating panel. The protective panels are then incorporated into the protective garment or gear. For illustrative purposes, the present invention will be described with respect to body armor. This invention can be used, however, with any product that would benefit from a protective barrier that substantially minimizes exposure to environmental factors.

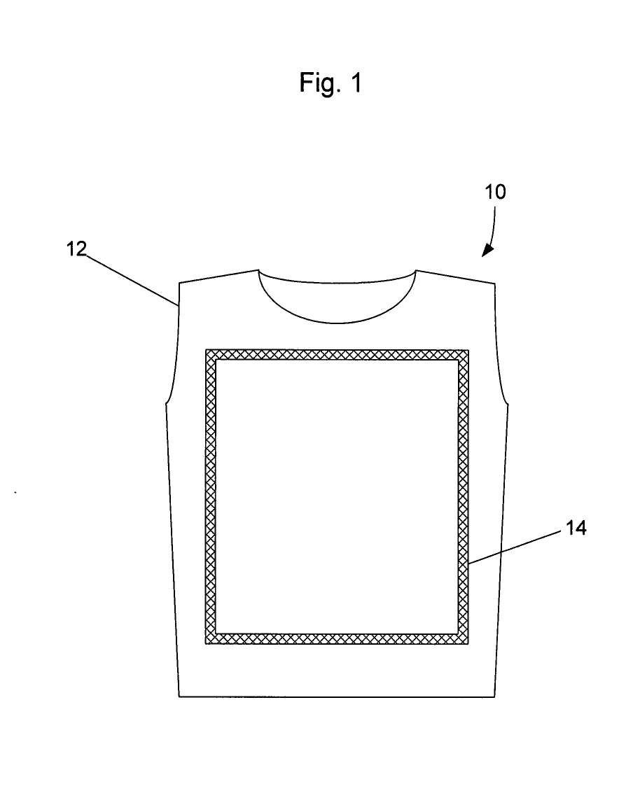

Typical body armor consists of a carrier, such as vest 12, that can carry a ballistic panel 14. FIG. 1 illustrates a bulletproof vest 10. While FIG. 1 shows only one ballistic panel 14 incorporated into vest 12, bulletproof vests and other types of body armor can carry any number of ballistic panels in a variety of locations depending on what part of the user's body is being protected, as is well known in the art.

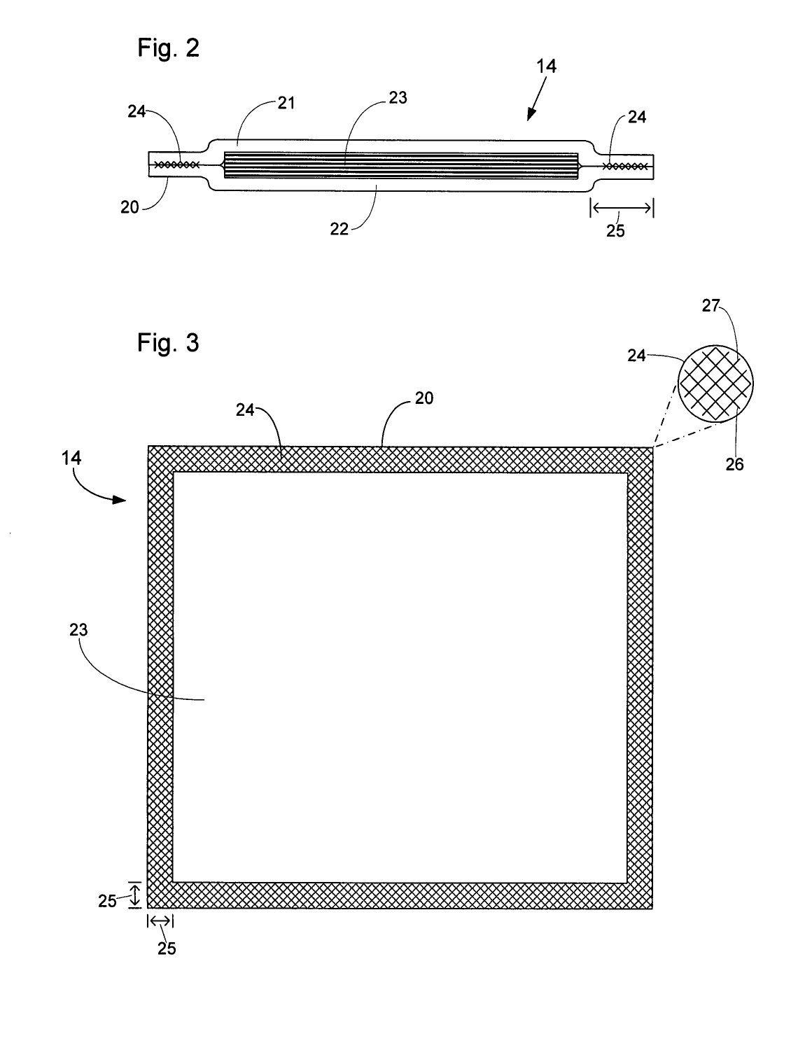

FIGS. 2 and 3 illustrate the ballistic panel 14. Ballistic panel 14 comprises a barrier 20 completely encasing ballistic material 23. Barrier 20 comprises one or more pieces of moisture-resistant and ultraviolet light-resistant material. FIGS. 2 and 3 show a first square piece 21 of such material and a second square piece 22 of such material. First piece 21 is positioned on top of the ballistic material 23, and second piece 22 is positioned below the ballistic material 23. Ballistic material 23 is sized slightly smaller than first and second pieces 21 and 22 so that there is excess material at the periphery of the pieces for attaching first piece 21 to second piece 22 at the piece edges 25. Preferably first piece 21 makes direct contact with second piece 22 at the piece edges 25, but an interlayer is contemplated for certain applications. Preferably, the edges 25 comprise between 0.25 inch and 0.5 inch of extra material along the perimeter of the ballistic material. The edges of first and second fabric panels 21 and 22 are attached to each other with a seam that is substantially impermeable to UV light and moisture, as explained in more detail below. When a single piece of material is used to form a barrier 20, the piece may be folded upon itself to form the enclosure, and the free ends sealed to prevent penetration by UV light and moisture.

Pieces 21 and 22 can be any shape or size, and additional pieces can be used depending on the contents to be encased by barrier 20. Preferably pieces 21 and 22 comprise a nylon fabric that is a minimum of 100 denier and coated with urethane. Nylon is desirable because it is UV resistant and a nylon measuring 100 denier is desirable because it allows for flexibility by the user while still prohibiting significant sunlight and moisture from penetrating the fabric. Urethane is desirable because it is moisture resistant and because it will stay pliable when ultrasonic energy is applied to produce a substantially impenetrable seam, as is done in the preferred embodiment. Alternatively, pieces 21 and 22 can be any other type of material that is able to withstand a minimum of two pounds per square inch of water pressure and provides a low UV light rating, such as woven, non-woven and knit textiles; thermoplastic films and laminates, and thermoplastic coated materials. As used herein, the UV rating indicates how effective a material is at blocking out solar ultraviolet radiation. A low rating indicates that little UV light permeates the material; a high rating indicates that high amounts of UV light gets through. The UV rating herein is analogous to the UV Index developed by the United States National Weather Service and Environmental Protection Agency which predicts the next day's ultraviolet radiation levels on a 1-11+ scale, (where 1 is low and 11 is high) helping people determine appropriate sun-protective behaviors.

The contents of barrier 20 can be anything that needs protection from environmental damage. For example, the contents can be insulation materials such as down feathers or protective textiles such as ballistic material 23. In the preferred embodiment of this invention, the contents comprise ballistic materials 23. Ballistic materials include aramid fabrics such as Kevlar®, Nomex®, and Twaron®; high performance polyethylene systems such as Dyneema® and Spectra Fibers ®; aramid barriers such as ColdFlox®; or poly-p-phenylene benzobisoxazole (PBO) fabrics such as Zylon®. Typically multiple layers of ballistic materials are used for increased protection.

The seam 24 that joins the pieces 21 and 22 together is substantially impervious to moisture and UV light. Preferably the seam 24 is an ultrasonic weld, which molecularly bonds pieces 21 and 22 together by melting the urethane, without melting the nylon. The current and frequency necessary for such a weld will depend on a number of factors, including the type of material(s), the desired speed of production, the temperature of the materials, the welder, etc. In the preferred embodiment, this bond is produced by applying about 0.9 amps at about 20 kHz of ultrasonic energy where the seam is desired. Preferably the ultrasonic energy is distributed at the rate of about 4.5 inches per second to the edges of pieces 21 and 22. In the preferred embodiment, all extra air is removed from barrier 20 immediately prior to completing the weld 24.

The seam 24 of barrier 20 preferably comprises a first set of parallel bonds 26 opposed to a second set of parallel bonds 27. The sets of bonds 26 and 27 are preferably oriented at about a 90 degree angle to each other, and both sets of bonds 26 and 27 meet the edge of pieces 21 and 22 at about a 45 degree angle. For moisture protection with acceptable seam flexibility, there are 2-18 parallel bonds per set. Preferably there are 14-18 bonds per set. The width of the ultrasonic weld is preferably between about 0.25 inch and about 0.5 inch. The preferred embodiment provides the necessary amount of flexibility at the weld preventing splitting or cracking of the bonds and, at the same time, provides the optimum amount of integrity under normal usage by minimizing bulk.

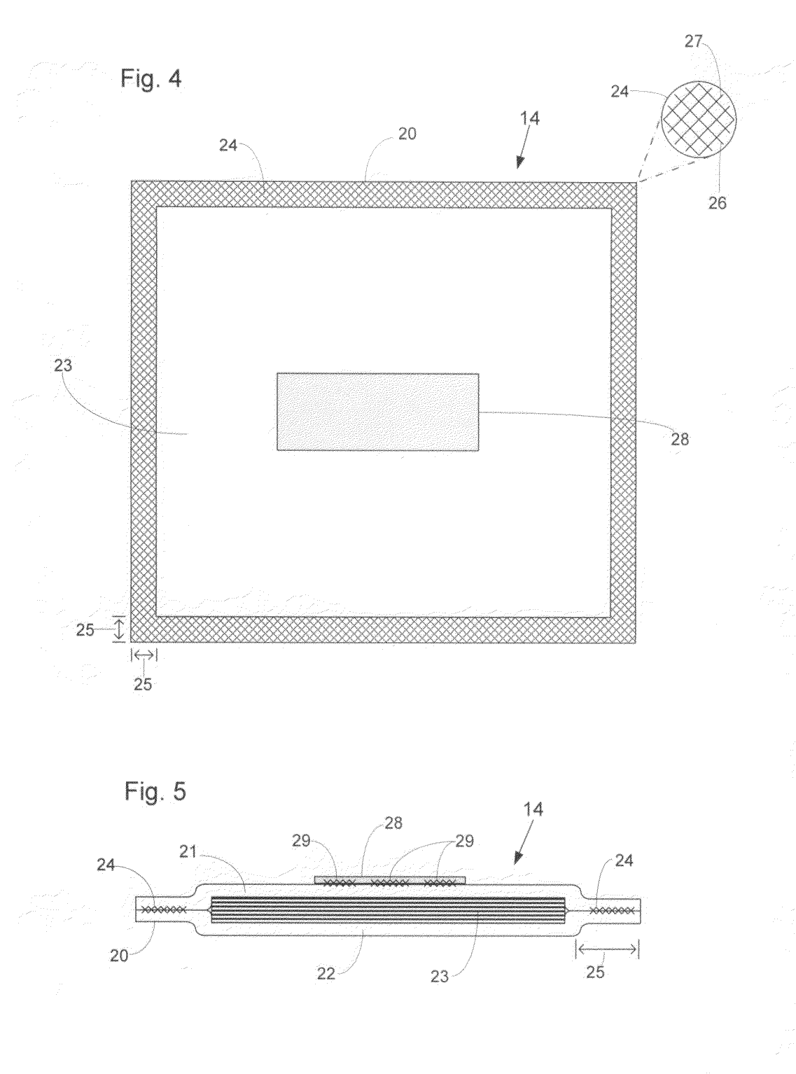

Optionally, attachments can be affixed to the barrier 20, as illustrated in FIGS. 4 and 5. The attachments are secured with by applying heat without compromising the protective features of barrier 20. For example, either the hook or loop portions of hook and loop fasteners (such as Velcro®) that have been treated to be heat bondable can be attached. Preferably the attachments are secured before the panels attached together. FIGS. 4 and 5 show the loop portion 28 of a heat bondable hook and loop fastener centrally placed on one fabric panel of barrier 20. While the attachment can be secured by ultrasonic welding, preferably the loop portion 28 is permanently affixed to barrier 20 utilizing a heat-activated glue that bonds when heated at a temperature of 146 degrees Celsius with a dwell time of about 4 seconds. This creates a permanent bond 29 between loop portion 28 and barrier 20. Any attachment that is heat bondable can be affixed to barrier 20 in this manner, as is known in the art. Such attachments include a heat bondable patch with a D-ring or loop for hanging tools from, a pocket, or a strap. Using heat, as opposed to sewing, to secure the attachment preserves the integrity of barrier 20.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

We claim:

1. A barrier protecting against environmental damage for use with safety and protective gear comprising:
a. ultraviolet light- and moisture-resistant material; and
b. where edges of the material are joined to each other, an ultraviolet light- and moisture-resistant seam.

2. The barrier of claim 1 wherein the material comprises nylon coated with urethane.

3. The barrier of claim 2 wherein the nylon is at least 100 denier.

4. The barrier of claim 1 wherein the material can withstand a minimum of two pounds per square inch of water pressure and has a low UV rating.

5. The barrier of claim 1 wherein the seam is made by applying ultrasonic energy to the material at a frequency of about 20 kHz.

6. The barrier of claim 5 wherein the seam is made by applying ultrasonic energy to the material at about 0.9 amps.

7. The barrier of claim 5 wherein the ultrasonic energy produces a first set of bonds opposed to a second set of bonds.

8. The barrier of claim 7 wherein the first set of bonds is oriented at about 90 degrees to the second set of bonds and wherein the first set of bonds and the second set of bonds are oriented at about 45 degrees to the edge of the material edge being ultrasonically welded.

9. The barrier of claim 7 wherein the first set of bonds further comprises 2-18 parallel bonds and the second set of bonds further comprises 2-18 parallel bonds.

10. The barrier of claim 1 wherein the seam width is at least 0.25 inch.

11. The barrier of claim 1 further comprising an attachment affixed to the barrier by applying heat.

12. The barrier of claim 11 wherein the attachment affixed to the barrier comprises the hook or loop portion of a hook and loop fastener.

13. The barrier of claim 1 further comprising ballistic material encased therein.

14. The barrier of claim 1 further comprising insulating material encased therein.

15. A protective panel for use in safety and protective gear comprising:
a. an ultraviolet light- and moisture-resistant barrier comprising:
i) ultraviolet light- and moisture-resistant fabric; and
ii) where fabric edges join, ultraviolet light- and moisture-resistant welds produced by applying ultrasonic energy; and
b. a protective material encased within the ultraviolet light- and moisture-resistant barrier;
c. wherein there are no gaps in the material or gaps in the welds; thereby substantially preventing ultraviolet light and moisture from penetrating the barrier and degrading the protective material.

16. The protective panel of claim 15 further comprising an attachment affixed to the exterior of the protective panel by applying heat.

17. The protective panel of claim 15 wherein:
a. the fabric edges are ultrasonically welded together using about 0.9 amps of ultrasonic energy at a frequency of about 20 kHz;
b. the ultrasonic energy produces a first set of molecular bonds opposed to a second set of bonds;
i) wherein the first set of bonds is oriented at about 90 degrees to the second set of bonds;
ii) the first set of bonds and the second set of bonds are offset about 45 degrees from the edge of the fabric edge being ultrasonically welded;
iii) the first set of bonds further comprises 2-18 parallel bonds and the second set of bonds further comprises 2-18 parallel bonds; and
iv) the ultrasonic weld width is at least 0.25 inch.

18. The protective panel of claim 15 wherein the fabric comprises nylon coated with urethane.

19. The protective panel of claim 15 wherein the protective material is a ballistic material.

20. A protective panel for use in safety and protective gear comprising:
a. ballistic material; and
b. an ultraviolet light- and moisture-resistant barrier encasing the ballistic material, the barrier comprising:
i) fabric comprising 100 denier nylon coated with urethane; and
ii) where the fabric edges join, ultraviolet light- and moisture-resistant welds produced by applying about 0.9 amps of ultrasonic energy at a frequency of about 20 kHz;
c. wherein the ultrasonic energy produces a first set of bonds is oriented at about 90 degrees to the second set of bonds and wherein both the first set of bonds and the second set of bonds are oriented at about 45 degrees from the edge of the fabric edge being ultrasonically welded;
d. wherein the first set of bonds further comprises 2-18 parallel bonds and the second set of bonds further comprises 2-18 parallel bonds and wherein the ultrasonic weld width is at least 0.25 inch; and
e. wherein there are no gaps in the fabric or gaps in the welds; thereby substantially preventing ultraviolet light and moisture from penetrating the barrier and degrading the ballistic material encased therein.
